(19) United States
(12) Patent Application Publication
(10) Pub. No.: US 2026/0222790 A1
(43) Pub. Date: Jul. 30, 2026

(54) LINK RECONFIGURATION FOR ROAMING EXECUTION PHASE HANDLING IN WLANS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Frisco, TX (US); Vishnu Vardhan Ratnam, Frisco, TX (US); Yue Qi, Plano, TX (US); Bilal Sadiq, Plano, TX (US)

(21) Appl. No.: 19/444,082

(22) Filed: Jan. 8, 2026

Related U.S. Application Data
(60) Provisional application No. 63/751,146, filed on Jan. 29, 2025.
(60) Provisional application No. 63/781,621, filed on Apr. 1, 2025.
(60) Provisional application No. 63/802,187, filed on May 8, 2025.
(60) Provisional application No. 63/910,244, filed on Nov. 3, 2025.

(51) Int. Cl. H04W 8/02; H04W 76/15

(52) U.S. Cl. CPC H04W 8/02; H04W 76/15

(57) ABSTRACT

Methods and apparatuses for a link reconfiguration procedure for roaming execution phase handling. A method of wireless communication performed by a non-access point (non-AP) multi-link device (non-AP MLD) includes transmitting, to a first AP MLD, a roam request frame to roam from the first AP MLD to a second AP MLD. The method further includes receiving, from the first AP MLD, a roam response frame that indicates that a seamless roam has been completed for the non-AP MLD to the second AP MLD such that the non-AP MLD remains in state 4 of association with a seamless mobility domain management entity (SMD-ME) while preserving context for data transmission when the non-AP MLD roams from the first AP MLD to the second AP MLD.

### CROSS-REFERENCE TO RELATED APPLICATION(S) AND CLAIM OF PRIORITY

This application claims priority under 35 U.S.C. § 119(e) to U.S. Provisional Patent Application No. 63/751,146, filed on Jan. 29, 2025, U.S. Provisional Patent Application No. 63/781,621, filed on Apr. 1, 2025, U.S. Provisional Patent Application No. 63/802,187, filed on May 8, 2025, and U.S. Provisional Patent Application No. 63/910,244, filed on Nov. 3, 2025, each of which are hereby incorporated by reference in their entirety.

### TECHNICAL FIELD

This disclosure relates generally to wireless communication, and more specifically to a link reconfiguration procedure for roaming execution phase handling in Wireless Local Area Networks (WLANs) including next generation WLANs.

### BACKGROUND

Wireless Local Area Network (WLAN) technology allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for a link reconfiguration for roaming execution phase handling in WLANs.

In one embodiment, a method of wireless communication performed by a non-access point (non-AP) multi-link device (non-AP MLD) includes transmitting, to a first AP MLD, a roam request frame to roam from the first AP MLD to a second AP MLD. The method further includes receiving, from the first AP MLD, a roam response frame that indicates that a seamless roam has been completed for the non-AP MLD to the second AP MLD such that the non-AP MLD remains in state 4 of association with a seamless mobility domain management entity (SMD-ME) while preserving context for data transmission when the non-AP MLD roams from the first AP MLD to the second AP MLD.

In another embodiment, a method performed by a first AP MLD includes receiving, from a first non-AP MLD, a roam request frame to roam from the first AP MLD to a second AP MLD. The method further comprises transmitting, to the first AP MLD, a roam response frame that indicates that a seamless roam has been completed for the non-AP MLD to the second AP MLD such that the non-AP MLD remains in state 4 of association with a seamless mobility domain management entity (SMD-ME) while preserving context for data transmission when the non-AP MLD roams from the first AP MLD to the second AP MLD.

In yet another embodiment, an electronic device comprises at least one processor including processing circuitry. The electronic device further comprises memory storing instructions, wherein the instructions, when executed by the at least one processor individually or collectively, cause the electronic device to: transmit, to a first AP MLD, a roam request frame to roam from the first AP MLD to a second AP MLD; and receive, from the first AP MLD, a roam response frame that indicates that a seamless roam has been completed for the non-AP MLD to the second AP MLD such that the non-AP MLD remains in state 4 of association with a seamless mobility domain management entity (SMD-ME) while preserving context for data transmission when the non-AP MLD roams from the first AP MLD to the second AP MLD.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example access point (AP) according to embodiments of the present disclosure;

FIG. 3 illustrates an example station (STA) according to embodiments of the present disclosure;

FIG. 4 illustrates an example of stages involved during a mobility handover procedure according to embodiments of the present disclosure;

FIG. 5 illustrates an example of link reconfiguration for adding and deleting links according to embodiments of the present disclosure;

FIG. 6 illustrates an example of using a link reconfiguration request frame to add links and perform a roam from the current AP MLD to the target AP MLD according to embodiments of the present disclosure;

FIG. 7 illustrates an example of a target AP MLD identifier in the common info field of the reconfiguration multi-link element according to embodiments of the present disclosure; and

FIG. 8 illustrates an example method performed by a non-access point (non-AP) multi-link device (non-AP MLD) in a wireless communication system according to embodiments of the present disclosure.

### DETAILED DESCRIPTION

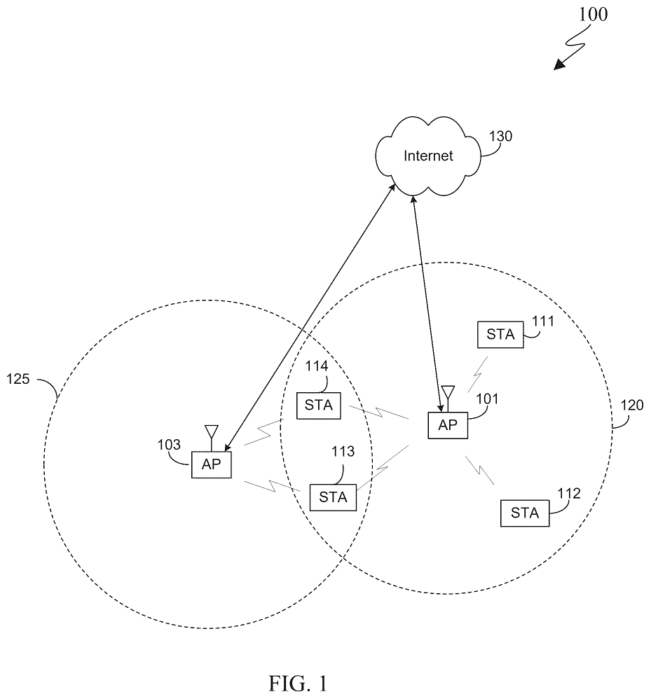

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE P802.11be/D7.0, 2024; [2] IEEE Std 802.11-2020; [3] IEEE P802.11bn/D0.1, 2025.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the APs may include circuitry and/or programming for facilitating a link reconfiguration procedure for roaming execution phase handling. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

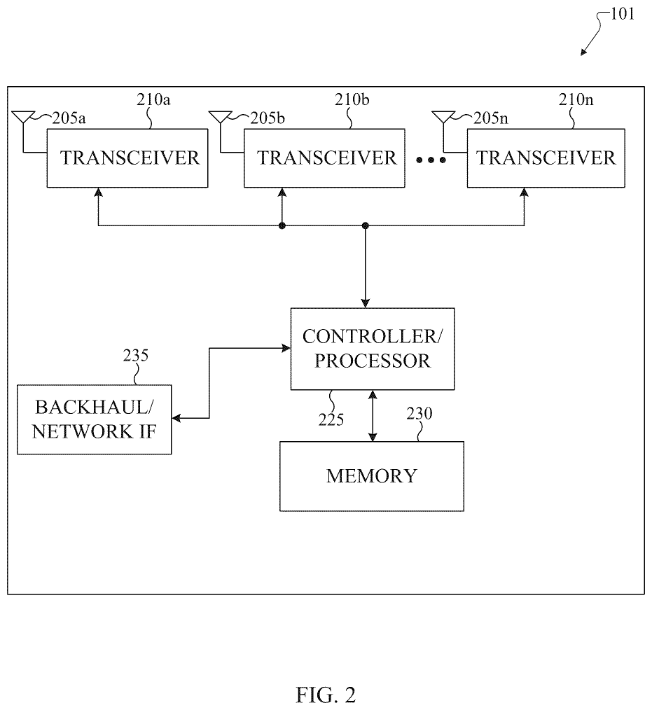

FIG. 2 illustrates an example AP 101 according to various embodiments of the present disclosure. The embodiment of the AP 101 illustrated in FIG. 2 is for illustration only, and the AP 103 of FIG. 1 could have the same or similar configuration. However, APs come in a wide variety of configurations, and FIG. 2 does not limit the scope of this disclosure to any particular implementation of an AP.

The AP 101 includes multiple antennas 205a-205n and multiple transceivers 210a-210n. The AP 101 also includes a controller/processor 225, a memory 230, and a backhaul or network interface 235. The transceivers 210a-210n receive, from the antennas 205a-205n, incoming radio frequency (RF) signals, such as signals transmitted by STAs 111-114 in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the AP 101. For example, the controller/processor 225 could control the reception of forward channel signals and the transmission of reverse channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing signals from multiple antennas 205a-205n are weighted differently to effectively steer the outgoing signals in a desired direction. The controller/processor 225 could also support OFDMA operations in which outgoing signals are assigned to different subsets of subcarriers for different recipients (e.g., different STAs 111-114). Any of a wide variety of other functions could be supported in the AP 101 by the controller/processor 225 including facilitating a link reconfiguration procedure for roaming execution phase handling. In some embodiments, the controller/processor 225 includes at least one microprocessor or microcontroller. The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the AP 101 to communicate with other devices or systems over a backhaul connection or over a network. The interface 235 could support communications over any suitable wired or wireless connection(s). For example, the interface 235 could allow the AP 101 to communicate over a wired or wireless local area network or over a wired or wireless connection to a larger network (such as the Internet). The interface 235 includes any suitable structure supporting communications over a wired or wireless connection, such as an Ethernet or RF transceiver. The memory 230 is coupled to the controller/processor 225. Part of the memory 230 could include a RAM, and another part of the memory 230 could include a Flash memory or other ROM.

As described in more detail below, the AP 101 may include circuitry and/or programming for facilitating a link reconfiguration procedure for roaming execution phase handling. Although FIG. 2 illustrates one example of AP 101, various changes may be made to FIG. 2. For example, the AP 101 could include any number of each component shown in FIG. 2. As a particular example, an access point could include a number of interfaces 235, and the controller/processor 225 could support routing functions to route data between different network addresses. Alternatively, only one antenna and transceiver path may be included, such as in legacy APs. Also, various components in FIG. 2 could be combined, further subdivided, or omitted, and additional components could be added according to particular needs.

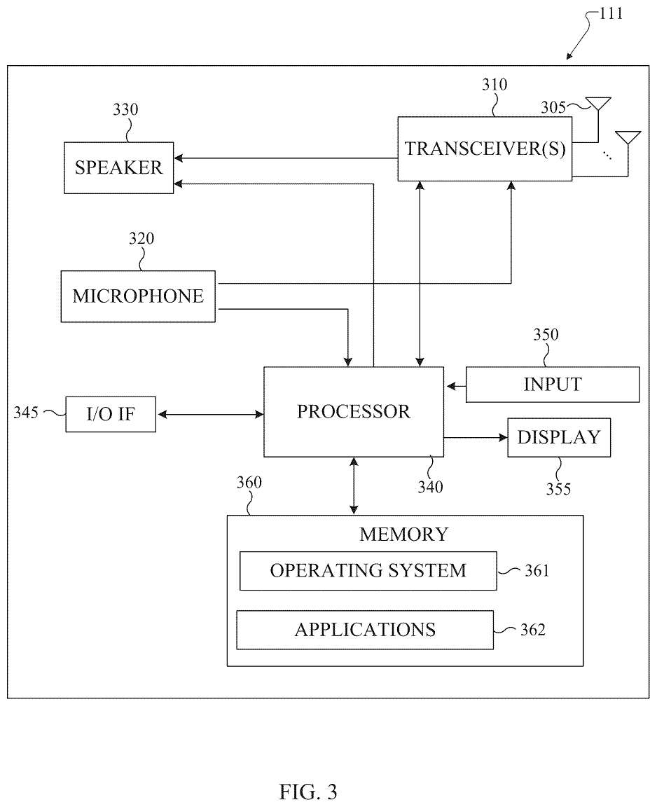

FIG. 3 illustrates an example STA 111 according to various embodiments of the present disclosure. The embodiment of the STA 111 illustrated in FIG. 3 is for illustration only, and the STAs 111-114 of FIG. 1 could have the same or similar configuration. However, STAs come in a wide variety of configurations, and FIG. 3 does not limit the scope of this disclosure to any particular implementation of a STA.

The STA 111 includes antenna(s) 305, transceiver(s) 310, a microphone 320, a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna(s) 305, an incoming RF signal (e.g., transmitted by an AP 101 of the network 100). The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors and execute the basic OS program 361 stored in the memory 360 in order to control the overall operation of the STA 111. In one such operation, the processor 340 controls the reception of forward channel signals and the transmission of reverse channel signals by the transceiver(s) 310 in accordance with well-known principles. The processor 340 can also include processing circuitry configured to facilitate a link reconfiguration procedure for roaming execution phase handling. In some embodiments, the processor 340 includes at least one microprocessor or microcontroller.

The processor 340 is also capable of executing other processes and programs resident in the memory 360, such as operations for facilitating a link reconfiguration procedure for roaming execution phase handling. The processor 340 can move data into or out of the memory 360 as required by an executing process. In some embodiments, the processor 340 is configured to execute a plurality of applications 362, such as applications for facilitating a link reconfiguration procedure for roaming execution phase handling. The processor 340 can operate the plurality of applications 362 based on the OS program 361 or in response to a signal received from an AP. The processor 340 is also coupled to the I/O interface 345, which provides STA 111 with the ability to connect to other devices such as laptop computers and handheld computers. The I/O interface 345 is the communication path between these accessories and the processor 340.

The processor 340 is also coupled to the input 350, which includes for example, a touchscreen, keypad, etc., and the display 355. The operator of the STA 111 can use the input 350 to enter data into the STA 111. The display 355 may be a liquid crystal display, light emitting diode display, or other display capable of rendering text and/or at least limited graphics, such as from web sites. The memory 360 is coupled to the processor 340. Part of the memory 360 could include a random-access memory (RAM), and another part of the memory 360 could include a Flash memory or other read-only memory (ROM).

Although FIG. 3 illustrates one example of STA 111, various changes may be made to FIG. 3. For example, various components in FIG. 3 could be combined, further subdivided, or omitted and additional components could be added according to particular needs. In particular examples, the STA 111 may include any number of antenna(s) 305 for MIMO communication with an AP 101. In another example, the STA 111 may not include voice communication or the processor 340 could be divided into multiple processors, such as one or more central processing units (CPUs) and one or more graphics processing units (GPUs). Also, while FIG. 3 illustrates the STA 111 configured as a mobile telephone or smartphone, STAs could be configured to operate as other types of mobile or stationary devices.

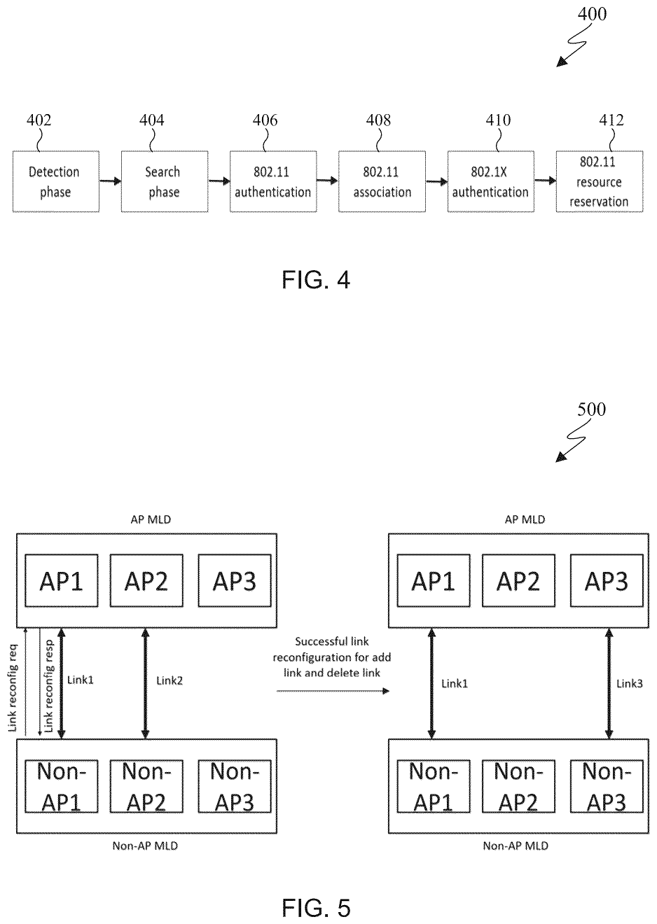

FIG. 4 illustrates an example of stages involved during a mobility handover procedure 400 according to embodiments of the present disclosure. For example, the mobility handover procedure 400 can be performed by any of the STAs 111-114, any of the APs 101, 103, and/or the network 130 of FIG. 1. The embodiment of the example of stages involved during a mobility handover procedure 400 shown in FIG. 4 is for illustration only. Other embodiments of the example of stages involved during a mobility handover procedure 400 could be used without departing from the scope of this disclosure.

As shown in FIG. 4, in legacy devices without any mobility support, the handover procedure involves the following steps:

1. Detection phase: during the detection phase 402, the STA determines that there is a need for a handover, and is typically left to vendor implementation. For example, a particular vendor implementation can choose to trigger handover when the signal strength to the currently associated AP drops below a certain threshold.

2. Search phase: the detection phase 402 is followed by a search phase 404. During the search phase 404, the STA searches for new APs to associate with. During the search phase 404, the STA performs a scan of different channels to identify APs in the vicinity. This can be done either passively (e.g., listening to beacons on a particular channel) or actively (e.g., by the use of probe request and response procedures). Passive scan can take a lot of time as the scanning STA needs to wait on each channel for a sufficient amount of time to ensure that the beacon is received from APs on that channel. Since each AP transmits beacons after a certain period of time (e.g., 100 ms), passive scan can consume a lot of time. In the case of active scan, the STA transmits a probe request and waits for a probe response from APs in the vicinity. Without prior knowledge of APs in the vicinity, active scan can take several seconds to complete.

3. 802.11 authentication: after the scanning procedure is complete, the next step is to perform 802.11 authentication 406 (open system/shared key based). Prior to authentication, the STA is in state 1 (unauthenticated and unassociated). Upon completion of authentication, the STA transitions into state 2 where the STA is authentication but unassociated.

4. 802.11 association: Once the STA is authenticated, the next step is to perform association 408. Upon completion of the association step, the STA transitions into state 3 which is authenticated and associated. At this stage, the 802.1X port is blocked.

5. 802.1X authentication: The authentication phase 410 comprises an EAP authentication between the STA and a AAA server with the assistance of the AP. Upon completion of this phase, the STA transitions into state 4 which is authenticated and associated and the 802.1X port is unblocked.

6. 802.11 resource reservation: Finally, in the resource reservation phase 412, the STA sets up various resources at the new AP. For example, the STA can perform QoS reservation, BA setup, etc. with the newly associated AP.

Typically, during a handover, there can be a disruption in the connection as the setup procedure operates in a break-before-make manner. This can cause an impact on user experience especially with multimedia services which can suffer from session disruptions due to the high delay encountered during handover procedure.

According to [3], the goal of seamless roaming is to provide mechanisms for a non-AP MLD to transition from the current AP MLD to the target AP MLD such that the time during which the connection is lost is minimal. The seamless roaming procedure can enable a non-AP MLD to remain in state 4 while transitioning from the current AP MLD to the target AP MLD.

The roaming procedure can comprise multiple stages. Two of the important stages are a preparation stage and roam execution stage. During the preparation stage, the non-AP MLD can setup links with the target AP MLD and perform context transfer. Following this stage, the non-AP MLD can perform a roam execution procedure by sending a request frame to transition from current AP MLD to target AP MLD. The current AP MLD can process the request frame and send a response frame to the non-AP MLD after the transfer of context is complete.

These procedures should be designed to enable the non-AP MLD to seamlessly roam from the current to the target AP MLD. [3] does not provide the procedures.

FIG. 5 illustrates an example of link reconfiguration for adding and deleting links 500 according to embodiments of the present disclosure. The embodiment of the example of link reconfiguration for adding and deleting links 500 shown in FIG. 5 is for illustration only. Other embodiments of the example of link reconfiguration for adding and deleting links 500 could be used without departing from the scope of this disclosure.

The baseline specification provides a link reconfiguration procedure to enable the non-AP MLD to add or delete one or more of its links with its current AP MLD. The add or delete operation can be performed by the non-AP MLD by transmitting a link reconfiguration request frame to the current AP MLD as depicted in FIG. 5.

Embodiments of the present disclosure recognize scenarios where a non-access point (non-AP) multi-link device (non-AP MLD) is connected to a seamless mobility domain (SMD). The SMD can include multiple access point (AP) multi-link devices (AP MLDs) where it can transition between the AP MLDs. There can be a seamless mobility domain management entity (SMD-ME) for the SMD. The SMD-ME can allow functionalities such as SMD-level authentication and association, IEEE 802.1X authenticator functions and robust security network association (RSNA) key management functions for non-AP MLDs across all AP MLDs within the SMD. The SMD can support two data path models between the non-AP MLD and the distribution system (DS). The first can be one that has one medium access control (MAC) service access point (SAP) for the SMD, and the second can be one that has a separate MAC SAP per AP MLD of the SMD. The SMD can only have one of these data path models used. The SMD and the 802.1X Authenticator component in the corresponding SMD-ME are uniquely identified by an SMD identifier.

The non-AP MLD performs an initial association with the SMD-ME through an AP MLD 1 within the SMD. This procedure establishes an SMD-level security association across all the AP MLDs in the SMD. At a later point in time, the non-AP MLD may need to transition from AP MLD 1 to an AP MLD 2 within the same SMD. To maintain a seamless roaming experience, it is necessary that the non-AP MLD remains in state 4 of association with the SMD-ME while preserving the context for a data transmission for a seamless experience. Signaling and procedures are needed to enable a seamless transition. The legacy specification does not provide the signaling. For instance, performing a (re) association with AP MLD 2 can put the non-AP MLD into state 1 with respect to AP MLD 2.

In the remainder of this disclosure, AP MLD 1 can be referred to as a current AP MLD and AP MLD 2 can be referred to as a target AP MLD.

Embodiments of the present disclosure provide mechanisms where the non-AP MLD can transmit a roam request to its current AP MLD to transition from the current AP MLD to the target AP MLD. The current AP MLD can communicate with the target AP MLD (over the wired network) to inform the target AP MLD about the transition. The current AP MLD can generate a roam response for the non-AP MLD and transmit to the non-AP MLD. The content of the roam request frame can be as described in section 1 herein. The content of the roam response frame can be as described in section 2 herein. The behavior on the non-AP MLD and the AP MLD sides can be as described in section 3 herein. When the non-AP MLD transmits a roam request to the current AP MLD, it is in state 4. As the links at the target AP MLD are added prior to the transition, when the non-AP MLD transitions to the target AP MLD, the non-AP MLD remains in state 4.

Embodiments of the present disclosure provide mechanisms where the entire roam procedure is viewed as an enhanced link reconfiguration operation. An enhanced link reconfiguration procedure is proposed by virtue of which the roam event can be viewed as adding links at the target AP MLD via the current AP MLD. Baseline or EHT link reconfiguration procedure allows a non-AP MLD to send link reconfiguration request to the ‘current AP MLD’ to add/delete links at the ‘current AP MLD’. The proposed enhanced link reconfiguration procedure is designed to allow a non-AP MLD to send a newly designed link reconfiguration request to the ‘current AP MLD’ to enable links at the target AP MLD. Details of the enhanced link reconfiguration procedure with respect to the behavior of the non-AP MLD, the current AP MLD and the target AP MLD are described in section 4 herein.

In this disclosure, a number of solutions are presented for handling roam transition phase signaling and behavior. The sections in this disclosure are as follows.
1. Roam request frame information content
2. Response frame information content
3. Behavior for handling request and response frames
4. Multi-link reconfiguration based roam

### 1. Roam Request Frame Information Content

According to one embodiment, the roam request frame can contain at least one or more of the information items shown in Table 1. The request frame can contain other information items not mentioned in Table 1.

TABLE 1
Information items present in a roam request frame

| Information item | Description |
|---|---|
| Target AP MLD | One or more information items that can indicate the target AP MLD. |
| identifier | For example, AP MLD ID, target AP MLD MAC address, UHR AP |
| | MLD ID, UHR AP MLD MAC address, etc. |
| Roam intent | One or more information items that can indicate the intent to roam from |
| indication | the current AP MLD to the target AP MLD. This can also indicate to |
| | the network that the DS remapping or route switching can occur. |
| | Examples of roam intent indication can be as shown in Table 2. |
| Request indicator | One or more information items that can serve as a reference for the |
| | request frame. For example, a dialog token. The response frame can |
| | carry the same dialog token as the request frame. |

TABLE 2
Examples of roam intent indication

| Information item | Description |
|---|---|
| Field based indication | A field that can take a predetermined value to indicate the intent to roam |
| | and can take another predetermined value to communicate the intent to |
| | not roam. |
| Bit based indication | A bit that can take a predetermined value (e.g., 1) to indicate the intent |
| | to roam and can take another predetermined value (e.g., 0) to |
| | communicate the intent to not roam. |

### 2. Response Frame Information Content

The response frame transmitted to the non-AP MLD can contain at least one or more of the information items as shown in Table 3. The response frame can contain other information items not mentioned in Table 3.

TABLE 3
Information items that can be present in the response frame

| Information item | Description |
|---|---|
| Association | One or more information items that can indicate association transfer |
| information | from the current AP MLD to the target AP MLD. For example, an |
| | AID, a tuple of AID and another parameter such as an AP identifier. |
| Roam confirmation | One or more information items that can indicate a confirmation that |
| | the non-AP MLD can roam to the target AP MLD. Examples of roam |
| | confirmation can be as shown in Table 4. This can also be interpreted |
| | as an indication that the route switch/DS remapping has occurred/is in |
| | process. |
| Roam deadline | One or more information items that can indicate a deadline before |
| | which the non-AP MLD can switch to the target AP MLD. For |
| | example, a deadline given in the units of micro-seconds or milli- |
| | seconds. |
| Response indication | One or more information items that can indicate the request to which |
| | the response corresponds to. For example, the same dialog token used |
| | in the request frame. |

TABLE 4
Examples of roam confirmation

| Information item | Description |
|---|---|
| Field based indication | A field that can take a predetermined value to indicate that the route |
| | switching is complete/DS remapping is completed. |
| Bit based indication | A bit that can take a predetermined value (e.g., 1) to indicate that the |
| | route switching is complete/DS remapping is complete and to another |
| | predetermined value (e.g., 0) to indicate otherwise. |
| Status information | A status code that can provide the status of the roam request frame. |
| | The status code can indicate statuses such as fail, success, etc. to |
| | indicate the status of the request. |

### 3. Behavior for Handling Request and Response Frames

Upon receiving the roam request frame, if the current AP MLD has the capability to enable a seamless roam for the non-AP MLD to the indicated target AP MLD, then the current AP MLD can perform the necessary procedure to enable a seamless roam of the non-AP MLD to the target AP MLD and transmit a response frame to the non-AP MLD with the indication. Examples of this situation can be cases wherein the current AP MLD and the target AP MLD are a part of the same UHR seamless roaming mobility domain, part of the same non-collocated AP MLD formation, etc.

Upon receiving the roam request frame, if the current AP MLD identifies that current AP MLD does not have the capability to enable a seamless roam for the non-AP MLD to the indicated target AP MLD, then the current AP MLD can transmit a response frame indicating to the non-AP MLD that the current AP MLD cannot enable a seamless roam to the target AP MLD. For instance, the current AP MLD can indicate a roam failure indication in the response frame. Examples of this situation can be cases wherein the current AP MLD and the target AP MLD are not a part of the same UHR seamless roaming mobility domain, not a part of the same non-collocated AP MLD formation, etc.

A non-AP MLD can refrain from transmitting a roam request frame that identifies a target AP MLD that the current AP MLD cannot enable a seamless roam to. The non-AP MLD can check the information advertised by the current AP MLD and other means possible (e.g., passive/active scanning for other AP MLDs) to identify the potential AP MLDs that can be considered as the target AP MLD to roam to via this current AP MLD.

When a non-AP MLD transmits a roam request frame that identifies a target AP MLD that the current AP MLD can enable a seamless roam to, the non-AP MLD can wait for a timeout period of time to receive the roam response frame from the current AP MLD. If the non-AP MLD receives the information within the timeout period, it can transition to the target AP MLD at a certain period of time. For example, when possible in implementation and prior to the deadline to roam.

When a non-AP MLD transmits a roam request frame that identifies a target AP MLD that the current AP MLD can enable a seamless roam to and does not receive a roam response frame from the current AP MLD within a timeout period, it can initiate another roam procedure by transmitting a request frame. The request frame can have the same dialog token as the previous request frame to convey that it is a duplicate. The request frame can also indicate a different dialog token if the non-AP MLD wants to start a fresh roam procedure. For example, if it wants to initiate a roam with another target AP MLD.

When a non-AP MLD transmits a roam request frame that identifies a target AP MLD that the current AP MLD can enable a seamless roam to and does not receive a roam response frame from the current AP MLD within a timeout period, the non-AP MLD can perform an association/(re) association procedure with a target AP MLD. This can be useful in scenarios where the signal strength to the current AP MLD has degraded significantly and communication is lost.

If the non-AP MLD does not roam to the target AP MLD prior to the deadline indicated in the response frame, the target AP MLD can disassociate the non-AP MLD. If the target AP MLD hears the non-AP MLD after the deadline, then the target AP MLD can either indicate to the non-AP MLD that it needs to perform a new association procedure or the non-AP MLD can be informed via the (previous) current AP MLD that the roam has failed.

If a non-AP MLD receives a failure indication for a roam request, then the non-AP MLD can transmit a initiate another roam request. This roam request can be to the same or a different AP MLD.

If a non-AP MLD has performed a preparation procedure to setup links with the target AP MLD and initiates a roam procedure accordingly (e.g., within a deadline indicated during the preparation procedure to initiate roam), then the current AP MLD can ensure that the roam is successful and that the non-AP MLD receives a response frame indicating a successful roam.

### 4. Multi-Link Reconfiguration Based Roam

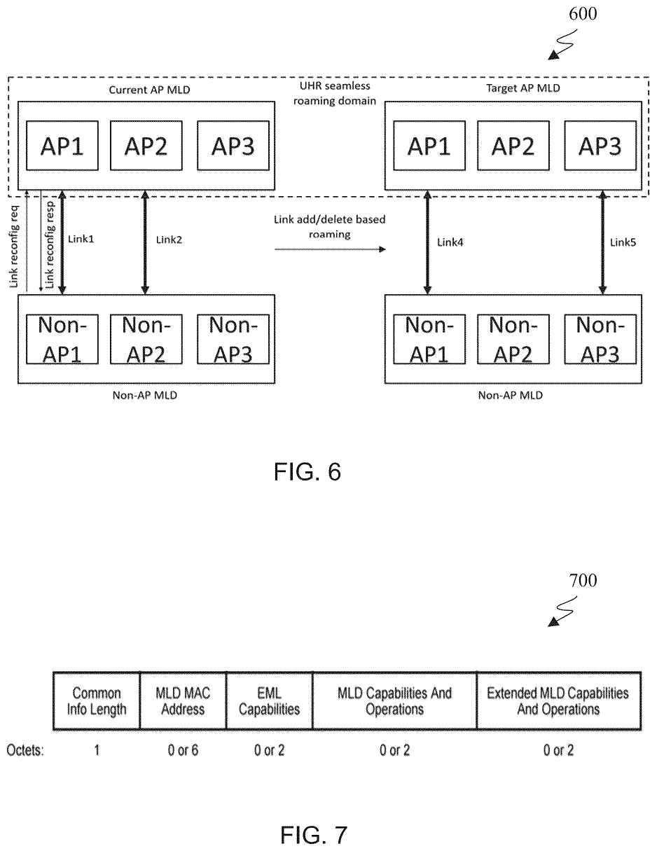

FIG. 6 illustrates an example of using a link reconfiguration request frame to add links and perform a roam from the current AP MLD to the target AP MLD 600 according to embodiments of the present disclosure. The embodiment of the example of using a link reconfiguration request frame to add links and perform a roam from the current AP MLD to the target AP MLD 600 shown in FIG. 6 is for illustration only. Other embodiments of the example of using a link reconfiguration request frame to add links and perform a roam from the current AP MLD to the target AP MLD 600 could be used without departing from the scope of this disclosure.

According to one embodiment, a link reconfiguration request frame can be used as the roam request frame. The modified link reconfiguration request frame can be used by the non-AP MLD to request addition and/or deletion of links to AP MLDs that are a part of the same seamless roaming framework as its current AP MLD. For example, if the current and the target AP MLD are a part of a seamless roaming mobility domain or a part of the same non-collocated AP MLD as shown in FIG. 6.

The link reconfiguration request frame can have an example format as shown in Table 5.

TABLE 5
Example modified link reconfiguration
request frame action field format

| Order | Meaning |
|---|---|
| 1 | Category |
| 2 | Protected UHR/EHT Action |
| 3 | Dialog token |
| 4 | Target AP MLD identifier |
| 5 | Roam intent indication/Execution |
| 6 | Reconfiguration Multi-link element |
| 7 | Operating Channel Information (OCI) element |

The order can be different than that shown in this example. There can also be additional information items present.

FIG. 7 illustrates an example of a target AP MLD identifier in the common info field of the reconfiguration multi-link element 700 according to embodiments of the present disclosure. The embodiment of a target AP MLD identifier in the common info field of the reconfiguration multi-link element 700 shown in FIG. 7 is for illustration only. Other embodiments of a target AP MLD identifier in the common info field of the reconfiguration multi-link element 700 could be used without departing from the scope of this disclosure.

As shown in FIG. 7, the target AP MLD identifier can also be present in the reconfiguration multi-link element. For example, in the common info field.

The MLD MAC address subfield specifies the MAC address of the target AP MLD.

The roam intent indication can also be present in the reconfiguration multi-link element. For example, in the reconfiguration operation type as shown in Table 6. When the reconfiguration operation type takes a value that indicates an intent to roam (e.g., 5), the current AP MLD can understand that the non-AP MLD intends to roam to a target AP MLD.

The roam intention indication in this disclosure can also be referred to as Execution.

TABLE 6
Example reconfiguration operation type

| Value | Name |
|---|---|
| 0 | AP removal |
| 1 | Operation parameter update |
| 2 | Add link |
| 3 | Delete link |
| 4 | NSTR status update |
| 5 | Roam intent indication/Execution |
| 6-15 | reserved |

The per-STA profile sub-element of the multi-link element can be absent in the link reconfiguration request frame.

The modified link reconfiguration response frame format can have an example format as shown in Table 7.

TABLE 7
Example link reconfiguration response frame action field format

| Order | Meaning |
|---|---|
| 1 | Category |
| 2 | Protected EHT/UHR Action |
| 3 | Dialog Token |
| 4 | AID |
| 5 | Roam Confirmation |
| 6 | Roam Deadline |
| 7 | Count |
| 8 | Reconfiguration Status List |
| 9 | Group Key Data (optional) |
| 10 | OCI element (optional) |
| 11 | Basic Multi-link element (optional) |

The order can be different than that shown in this example. There can also be additional information items present.

The response can contain an AID that is assigned for the non-AP MLD to communicate with the target AP MLD. The non-AP MLD can use the AID for communication at the target AP MLD.

The roam confirmation can also be implicitly indicated in the status subfield in the reconfiguration status duple subfield. The status subfield can indicate the status of the operation for the link corresponding to the link ID subfield and have a status code value that indicates a successful/failed link setup/roam execution at the target AP MLD for the indicated link ID. The status can be either for individual links or for the entire roam operation. If the status code is failure, it can indicate that the timeout a preparation procedure performed preceding the execution procedure has timed out or the target AP MLD has not been prepared for the non-AP MLD for roaming. If the status code is successful, then the non-AP MLD can transition to the target AP MLD. If the status code is a failure, the non-AP MLD can initiate a preparation procedure again with the target AP MLD or perform an execution to another target AP MLD.

According to one embodiment, if the link status code in the response frame indicates a success, then the non-AP MLD can consider it as an indication of a successful route switch/DS remapping to the target AP MLD.

If a preparation procedure is completed and the links are already added, the information exchanged during the preparation procedure (e.g., the group key data, OCI element, Basic Multi-link element, etc.) can be skipped in the link reconfiguration response frame when used as a roam response frame.

If a preparation procedure is not completed or there is an update to the parameters associated with the links added during the preparation procedure, then the necessary information (e.g., group key data, basic multi-link element, etc.) can be added in the reconfiguration response frame when used as a roam response frame.

The roam deadline can indicate the time before which the non-AP MLD can transition to the target AP MLD.

The group key data can refer to the group keys of the successfully setup links at the target AP MLD.

According to another embodiment, the group key data can be included in the link reconfiguration response frame for successfully setup links at the target AP MLD.

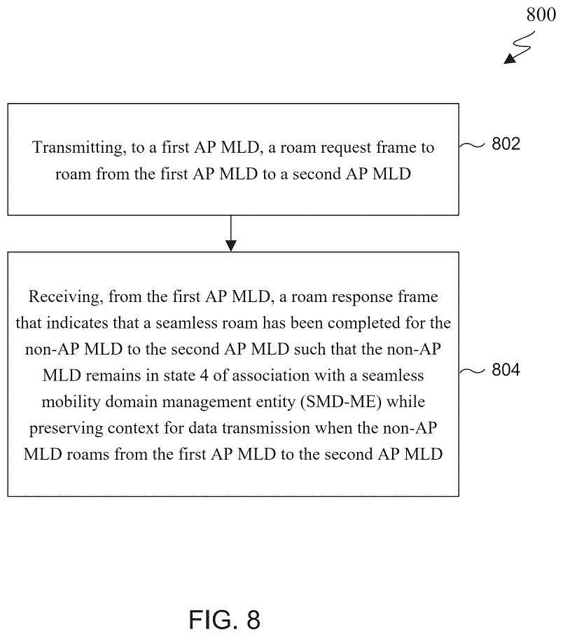

FIG. 8 illustrates an example method 800 performed by a non-AP MLD in a wireless communication system according to embodiments of the present disclosure. The method 800 of FIG. 8 can be performed by any of the STAs 111-114 of FIG. 1, such as the STA 111 of FIG. 3, and a corresponding method can be performed by any of the APs 101-103 of FIG. 1, such as AP 101 of FIG. 2. The method 800 is for illustration only and other embodiments can be used without departing from the scope of the present disclosure.

As illustrated in FIG. 8, the method 800 begins at step 802, where the non-AP MLD transmits, to a first AP MLD, a roam request frame to roam from the first AP MLD to a second AP MLD. At step 804, the non-AP MLD receives, from the first AP MLD, a roam response frame that indicates that a seamless roam has been completed for the non-AP MLD to the second AP MLD such that the non-AP MLD remains in state 4 of association with a seamless mobility domain management entity (SMD-ME) while preserving context for data transmission when the non-AP MLD roams from the first AP MLD to the second AP MLD.

In some embodiments, the roam request frame includes at least one of: an information item that indicates the second AP MLD; an information item that indicates an intent to roam from the first AP MLD to the second AP MLD; and an information item that serves as a reference for the roam request frame.

In some embodiments, the roam response frame includes at least one of: an information item that indicates association transfer from the first AP MLD to the second AP MLD; an information item that indicates a confirmation that the non-AP MLD can roam to the second AP MLD, including at least one of a field based indication, a bit based indication, and status information; an information item that indicates a deadline before which the non-AP MLD can switch to the second AP MLD; group keys of successfully set up links at the second AP MLD; and an information item that indicates a request to which the roam response frame corresponds.

In some embodiments, the roam request frame comprises a link reconfiguration request frame to request to switch to links that were added during a preparation phase of a connection process to the second AP MLD; the roam response frame comprises a link reconfiguration response frame and the first AP MLD and the second AP MLD are in a same seamless roaming framework.

In some embodiments, an action field of the link reconfiguration request frame includes at least one of a category, a protected ultra-high reliability/extremely high throughput (UHR/EHT) action, a dialog token, a target AP MLD identifier, a roam intent indication, a reconfiguration multi-link element, and an operation channel information (OCI) element.

In some embodiments, an action field of the link reconfiguration response frame includes at least one of a category, a protected ultra-high reliability/extremely high throughput (UHR/EHT) action, a dialog token, an association identification (AID), a roam confirmation, a roam deadline, a count, a reconfiguration status list, a group key data, an operation channel information (OCI) element, and a multi-link element.

In some embodiments, the non-AP MLD uses the AID for communication at the second AP.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by a non-access point (non-AP) multi-link device (non-AP MLD), the method comprising:
transmitting, to a first access point (AP) MLD, a roam request frame to roam from the first AP MLD to a second AP MLD; and
receiving, from the first AP MLD, a roam response frame that indicates that a seamless roam has been completed for the non-AP MLD to the second AP MLD such that the non-AP MLD remains in state 4 of association with a seamless mobility domain management entity (SMD-ME) while preserving context for data transmission when the non-AP MLD roams from the first AP MLD to the second AP MLD.

2. The method of claim 1, wherein the roam request frame includes at least one of:
an information item that indicates the second AP MLD;
an information item that indicates an intent to roam from the first AP MLD to the second AP MLD; and
an information item that serves as a reference for the roam request frame.

3. The method of claim 1, wherein the roam response frame includes at least one of:
an information item that indicates association transfer from the first AP MLD to the second AP MLD;
an information item that indicates a confirmation that the non-AP MLD can roam to the second AP MLD, including at least one of a field based indication, a bit based indication, and status information;
an information item that indicates a deadline before which the non-AP MLD can switch to the second AP MLD;
group keys of successfully set up links at the second AP MLD; and
an information item that indicates a request to which the roam response frame corresponds.

4. The method of claim 1, wherein:
the roam request frame comprises a link reconfiguration request frame to request to switch to links that were added during a preparation phase of a connection process to the second AP MLD;
the roam response frame comprises a link reconfiguration response frame and
the first AP MLD and the second AP MLD are in a same seamless roaming framework.

5. The method of claim 4, wherein an action field of the link reconfiguration request frame includes at least one of a category, a protected ultra-high reliability/extremely high throughput (UHR/EHT) action, a dialog token, a target AP MLD identifier, a roam intent indication, a reconfiguration multi-link element, and an operation channel information (OCI) element.

6. The method of claim 4, wherein an action field of the link reconfiguration response frame includes at least one of a category, a protected ultra-high reliability/extremely high throughput (UHR/EHT) action, a dialog token, an association identification (AID), a roam confirmation, a roam deadline, a count, a reconfiguration status list, a group key data, an operation channel information (OCI) element, and a multi-link element.

7. The method of claim 6, further comprising using the AID for communication at the second AP.

8. A method performed by a first access point (AP) multi-link device (AP MLD), the method comprising:
receiving, from a first non-AP MLD, a roam request frame to roam from the first AP MLD to a second AP MLD; and
transmitting, to the first AP MLD, a roam response frame that indicates that a seamless roam has been completed for the non-AP MLD to the second AP MLD such that the non-AP MLD remains in state 4 of association with a seamless mobility domain management entity (SMD-ME) while preserving context for data transmission when the non-AP MLD roams from the first AP MLD to the second AP MLD.

9. The method of claim 8, wherein the roam request frame includes at least one of:
an information item that indicates the second AP MLD;
an information item that indicates an intent to roam from the first AP MLD to the second AP MLD; and
an information item that serves as a reference for the roam request frame.

10. The method of claim 8, wherein the roam response frame includes at least one of:
an information item that indicates association transfer from the first AP MLD to the second AP MLD;
an information item that indicates a confirmation that the non-AP MLD can roam to the second AP MLD, including at least one of a field based indication, a bit based indication, and status information;
an information item that indicates a deadline before which the non-AP MLD can switch to the second AP MLD;
group keys of successfully set up links at the second AP MLD; and
an information item that indicates a request to which the roam response frame corresponds.

11. The method of claim 8, wherein:
the roam request frame comprises a link reconfiguration request frame to request to switch to links that were added during a preparation phase of a connection process to the second AP MLD;
the roam response frame comprises a link reconfiguration response frame and
the first AP MLD and the second AP MLD are in a same seamless roaming framework.

12. The method of claim 11, wherein an action field of the link reconfiguration request frame includes at least one of a category, a protected ultra-high reliability/extremely high throughput (UHR/EHT) action, a dialog token, a target AP MLD identifier, a roam intent indication, a reconfiguration multi-link element, and an operation channel information (OCI) element.

13. The method of claim 11, wherein an action field of the link reconfiguration response frame includes at least one of a category, a protected ultra-high reliability/extremely high throughput (UHR/EHT) action, a dialog token, an association identification (AID), a roam confirmation, a roam deadline, a count, a reconfiguration status list, a group key data, an operation channel information (OCI) element, and a multi-link element.

14. An electronic device of a non-access point (non-AP) multi-link device (non-AP MLD), the electronic device comprising:
at least one processor including processing circuitry; and
memory storing instructions, wherein the instructions, when executed by the at least one processor individually or collectively, cause the electronic device to:
transmit, to a first access point (AP) MLD, a roam request frame to roam from the first AP MLD to a second AP MLD; and
receive, from the first AP MLD, a roam response frame that indicates that a seamless roam has been completed for the non-AP MLD non-access point (non-AP) multi-link device (non-AP MLD) to the second AP MLD such that the non-AP MLD remains in state 4 of association with a seamless mobility domain management entity (SMD-ME) while preserving context for data transmission when the non-AP MLD roams from the first AP MLD to the second AP MLD.

15. The electronic device of claim 14, wherein the roam request frame includes at least one of:
an information item that indicates the second AP MLD;
an information item that indicates an intent to roam from the first AP MLD to the second AP MLD; and
an information item that serves as a reference for the roam request frame.

16. The electronic device of claim 14, wherein the roam response frame includes at least one of:
an information item that indicates association transfer from the first AP MLD to the second AP MLD;
an information item that indicates a confirmation that the non-AP MLD can roam to the second AP MLD, including at least one of a field based indication, a bit based indication, and status information;
an information item that indicates a deadline before which the non-AP MLD can switch to the second AP MLD;
group keys of successfully set up links at the second AP MLD; and
an information item that indicates a request to which the roam response frame corresponds.

17. The electronic device of claim 14, wherein:
the roam request frame comprises a link reconfiguration request frame to request to switch to links that were added during a preparation phase of a connection process to the second AP MLD;
the roam response frame comprises a link reconfiguration response frame; and
the first AP MLD and the second AP MLD are in a same seamless roaming framework.

18. The electronic device of claim 17, wherein an action field of the link reconfiguration request frame includes at least one of a category, a protected ultra-high reliability/extremely high throughput (UHR/EHT) action, a dialog token, a target AP MLD identifier, a roam intent indication, a reconfiguration multi-link element, and an operation channel information (OCI) element.

19. The electronic device of claim 17, wherein an action field of the link reconfiguration response frame includes at least one of a category, a protected ultra-high reliability/extremely high throughput (UHR/EHT) action, a dialog token, an association identification (AID), a roam confirmation, a roam deadline, a count, a reconfiguration status list, a group key data, an operation channel information (OCI) element, and a multi-link element.

20. The electronic device of claim 19, wherein the instructions, when executed by the at least one processor individually or collectively, cause the electronic device to use the AID for communication at the second AP.
